(19) United States
(12) Patent Application Publication
(10) Pub. No.: US 2021/0157925 A1
(43) Pub. Date: May 27, 2021

(54) SELECTIVE RUNTIME ACTIVATION OF ANTI-ROP DEFENSE

(71) Applicant: International Business Machines Corporation, Armonk, NY (US)

(72) Inventors: FADY COPTY, Nazareth (IL); Shai Doron, Kibutz Meggido (IL)

(21) Appl. No.: 16/695,330

(22) Filed: Nov. 26, 2019

(51) Int. Cl. G06F 21/57; G06N 20/00; G06N 5/04

(52) U.S. Cl. CPC G06F 21/577; G06F 2221/034; G06N 5/04; G06N 20/00

(57) ABSTRACT

A method, an apparatus and a computer program product for detecting and protecting against just-in-time Return-Oriented Programming (ROP) attacks on computer code by selective runtime activation of anti-ROP defenses. The method comprises executing a dynamic agent while the computer code is being executed that monitors for exploitation of memory exposure vulnerabilities and flow hijack vulnerabilities within the computer code. The dynamic agent identifies, during execution of the computer code, an exposed portion of the computer code that was exposed by the exploitation of the one or more memory exposure vulnerabilities. In o response to the identification of the exposed portion of the computer code, the dynamic agent performs an anti-ROP defense on the exposed portion.

### TECHNICAL FIELD

The present disclosure relates to computer security in general, and to detecting and protecting against just-in-time Return-Oriented Programming (ROP) attacks on computer programs, in particular.

### BACKGROUND

One of the modern software attacks is Return-Oriented Programming (ROP). ROP is a common technique for exploiting code vulnerabilities. ROP attacks may allow an attacker to execute code in the presence of security defenses, such as executable space protection and code signing.

In ROP attacks, no code is injected by the attacker, but rather one or more portions of legitimate code may be executed, such that their combined functionality is harmful. As part of a ROP attack, the stack is overwritten, so that when the instruction pointer returns from a call, the overwritten return addresses point to one or more gadgets, being sequences of instructions each ending with a return statement, such that their combined functionality is equivalent to a malicious code as designed by the attacker. The attacker may gain control of the call stack to hijack program control flow and then executes carefully chosen machine instruction sequences that are already present in the machine's memory, e.g., the gadgets. Each gadget typically ends in a return instruction (e.g., instructions each ending with a return statement) and is located in a subroutine within the existing program or shared library code. Chained together, these gadgets may allow an attacker to perform arbitrary operations on a machine employing defenses that thwart simpler attacks.

Thus, in ROP attacks, chunks of code ending with a return instruction, which exist in a program or in an available library such as kernel32.dll, user32.dll or the like, are used. The chunks of code perform legitimate needed functionality, but are misused to perform malicious activity. Searching for such chunks to be used in an attack is an easy task, and tools exist that are operative in building the addresses that are to be injected to the stack such that these chunks are executed.

### BRIEF SUMMARY

One exemplary embodiment of the disclosed subject matter is a method comprising: providing security information regarding a computer code to a dynamic agent, wherein the security information comprises: one or more memory exposure vulnerabilities within the computer code and one or more control flow hijack vulnerabilities within the computer code; and executing the dynamic agent while the computer code is being executed; wherein the dynamic agent is configured to monitor for exploitation of the one or more memory exposure vulnerabilities, wherein the dynamic agent is configured to identify, during execution of the computer code, an exposed portion of the computer code that was exposed by the exploitation of the one or more memory exposure vulnerabilities, wherein in response to the identification of the exposed portion of the computer code, the dynamic agent is configured to perform an anti-ROP defense.

Optionally, the anti-ROP defense comprises performing an on-the-fly randomization of at least a portion of the computer code.

Optionally, the anti-ROP defense comprises randomizing locations of instructions within the exposed portion of the computer code.

Optionally, the anti-ROP defense comprises modifying entry points of all control flow hijack vulnerabilities located within the exposed portion of the computer code.

Optionally, the anti-ROP defense comprises: identifying an address potentially injected to be utilized during exploitation of a control flow hijack vulnerability, wherein the address points to an instruction; and modifying a location of the instruction pointed to by the address.

Optionally, the dynamic agent is configured to record potential control flow values utilized by the one or more control-flow hijack vulnerabilities; and wherein the anti-ROP defense comprises overwriting a control flow value that is utilized by at least one control-flow hijack vulnerability.

Optionally, the anti-ROP defense is performed only with respect to control flow values of the exposed portion of the computer code.

Optionally, the method further comprising: performing static analysis of the computer code to determine the one or more memory exposure vulnerabilities and the one or more control flow hijack vulnerabilities within the computer code.

Optionally, the static analysis is performed offline prior to executing the computer code.

Optionally, said executing the dynamic agent is performed during execution of the computer code, wherein the dynamic agent is executed separately from the computer code.

Optionally, the dynamic agent is embedded into an executable of the computer code, whereby execution of the computer code also executes the dynamic agent.

Optionally, the method further comprising: determining one or more exploitation conditions for exploiting the one or more memory exposure vulnerabilities or the one or more control flow hijack vulnerabilities; wherein the anti-ROP defense is performed in response to the one or more exploitation conditions being met.

Another exemplary embodiment of the disclosed subject matter is a computerized apparatus having a processor, the processor being adapted to perform the steps of: providing security information regarding a computer code to a dynamic agent, wherein the security information comprises: one or more memory exposure vulnerabilities within the computer code and one or more control flow hijack vulnerabilities within the computer code; and executing the dynamic agent while the computer code is being executed; wherein the dynamic agent is configured to monitor for exploitation of the one or more memory exposure vulnerabilities, wherein the dynamic agent is configured to identify, during execution of the computer code, an exposed portion of the computer code that was exposed by the exploitation of the one or more memory exposure vulnerabilities, wherein in response to the identification of the exposed portion of the computer code, the dynamic agent is configured to perform an anti-ROP defense.

Yet another exemplary embodiment of the disclosed subject matter is a computer program product comprising a non-transitory computer readable storage medium retaining program instructions, which program instructions when read by a processor, cause the processor to perform a method comprising: providing security information regarding a computer code to a dynamic agent, wherein the security information comprises: one or more memory exposure vulnerabilities within the computer code and one or more control flow hijack vulnerabilities within the computer code; and executing the dynamic agent while the computer code is being executed; wherein the dynamic agent is configured to monitor for exploitation of the one or more memory exposure vulnerabilities, wherein the dynamic agent is configured to identify, during execution of the computer code, an exposed portion of the computer code that was exposed by the exploitation of the one or more memory exposure vulnerabilities, wherein in response to the identification of the exposed portion of the computer code, the dynamic agent is configured to perform an anti-ROP defense.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter;

FIGS. 2A and 2B show flowchart diagrams of methods, in accordance with some exemplary embodiments of the disclosed subject matter;

FIG. 3 shows a flowchart diagram of a method, in accordance with some exemplary embodiments of the disclosed subject matter; and

FIG. 4 shows a block diagram of an apparatus, in accordance with some exemplary embodiments of the disclosed subject matter.

### DETAILED DESCRIPTION

One technical problem dealt with by the disclosed subject matter is protecting from Just-in-Time-ROP (JIT-ROP) attacks on computers without introducing major performance penalty and liability risk. JIT-ROP is a vulnerability exploit technique that exploits vulnerabilities in computer code in order to execute an attack. JIT-ROP may exploit a memory exposure vulnerability in order to learn a state of the memory, location of code segments, or the like, such as by scanning the code loaded to the memory. JIT-ROP may compile a ROP attack based on the memory state to exploit another vulnerability to hijack the computer code control flow. In JIT-ROP attacks, the attacker gains control of the call stack to hijack program control flow and then executes carefully chosen machine instruction sequences that are already present in the machine's memory. Each instruction sequence typically ends in a return instruction and is located in a subroutine within the existing program and/or shared library code. Overflow vulnerabilities may use the JIT-ROP technique in order to execute code on the system, based on the state of the memory during runtime of the attacked program.

In some exemplary embodiments, JIT-ROP attacks may bypass anti-ROP defense mechanisms, such as Address Space Layout Randomization (ASLR), fine-grained ASLR, Canary randomization, memory-access sanitation, Control Flow Integrity (CFI) techniques, or the like, as such anti-ROP defense mechanisms perform their actions at build time or load time of the computer code, and may fail against the run-time nature of JIT-ROP. Additionally or alternatively, anti-JIT-ROP defense mechanisms may defend against JIT-ROP attacks by introducing continuous run-time self-modification of the computer code, continuous code randomization, run time self-modification on every output generation, periodical run-timecode randomization, randomizing the entire computer code, or the like. Such run-time randomization techniques may introduce major performance penalty and high reliability risk when activated continually over the entire codebase. Randomizing the entire computer code may expose to a high risk of introducing defects due to the randomization and the complicated task of testing of all possible randomizations.

In some exemplary embodiments, it may be desirable to provide for a robust JIT-ROP prevention technique, which has minimal negative effect on the user experience such as by avoiding substantial degradation in performance when a protected program is loaded and executed, avoiding substantial increase in resource consumption, or the like, without introducing major performance penalty and liability risk.

One technical solution is to provide for a place-and-time specific defense against JIT-ROP attacks by performing selective runtime activation of anti-ROP defense. In some exemplary embodiments, JIT-ROP attacks may comprise two main stages: exploiting read vulnerabilities in the attacked computer code for memory disclosure and exploiting write vulnerabilities in the attacked computer code to hijack the code control flow. Exploiting the read vulnerabilities may enable the attacker to map, at runtime, the memory layout of the attacked computer code and dynamically discover Application Programming Interface (API) functions and gadgets. A malicious computer code composed of a sequence of the attacked computer code API functions and gadgets may be JIT-compiled, e.g., compiled into the attacked computer code during runtime thereof. Exploiting the write vulnerabilities may enable the attacker to divert execution to the malicious computer code composed based on exploiting the read vulnerabilities.

In some exemplary embodiments, static analysis techniques may be utilized to determine security information regarding vulnerabilities in a computer code. The computer code may be a source code of a computer program, an application, or the like. The security information may comprise all possible security vulnerabilities in the computer code, such as memory exposure vulnerabilities, buffer overflow vulnerabilities, control flow hijack vulnerabilities, or the like. In some exemplary embodiments, the static analysis may be performed offline prior to executing the computer code. It may be noted that the security information may comprise both true-positive and false-positive information regarding vulnerabilities in the computer code, e.g., some vulnerabilities determined by the static analysis may not be actual vulnerabilities, may not be exploited during execution of the computer code, may not possible to be exploited, or the like. Additionally or alternatively, the symbolic analysis may be leveraged to determine conditions for vulnerability exploitation, expected exposure ranges of the read vulnerabilities, expected control-flow points to be exploited by the write vulnerabilities, or the like.

In some exemplary embodiments, vulnerabilities in the security information may be divided into read vulnerabilities, such as memory exposure vulnerabilities, and write vulnerabilities, such as control flow hijack vulnerabilities. Exploitation of the memory exposure vulnerabilities (or any other read vulnerabilities) may be monitored, during execution of the computer code.

In some exemplary embodiments, the security information may be provided to a dynamic agent. The dynamic agent may be executed during execution of the computer code. The dynamic agent may be executed separately from the computer code, may be embedded into an executable of the computer code, or the like. The dynamic agent may be configured to monitor for exploitation of the memory exposure vulnerabilities. The dynamic agent may be configured to identify, during execution of the computer code, the exposed portion of the computer code that was exposed by the exploitation of the one or more memory exposure vulnerabilities. The dynamic agent may be configured to activate an anti-ROP defense in response to identification of the exposed portion of the code. The anti-ROP defense may comprise performing an on-the-fly randomization of at least a portion of the computer code, such as the exposed portion or portions thereof, locations of instructions within the exposed portion of the computer code, or the like.

Additionally or alternatively, the anti-ROP defense may comprise modifying entry points of all control flow hijack vulnerabilities located within the exposed portion of the computer code. In case of an exploitation of a memory exposure vulnerability, entry points of all control flow hijack vulnerabilities (or any other write vulnerabilities) located within an exposed range (e.g., exposed portion of the computer code that was exposed by the exploitation of the memory exposure vulnerability) of the memory exposure vulnerability, may be modified.

Additionally or alternatively, the anti-ROP defense may be in response to one or more exploitation conditions for exploiting the one or more memory exposure vulnerabilities or the one or more control flow hijack vulnerabilities, being met. In some exemplary embodiments, the anti-ROP defense may be configured to identify one or more addresses potentially injected to be utilized during exploitation of a control flow hijack vulnerability. Each address may point to an instruction within the computer code. The anti-ROP defense may be configured to modify a location of the instruction pointed to by each address. Additionally or alternatively, potential control flow values utilized by the one or more control-flow hijack vulnerabilities may be recorded (such as by the dynamic agent). The anti-ROP defense may overwrite such potential control flow. It may be appreciated that the anti-ROP defense may be performed only with respect to control flow values within the exposed portion of the computer code.

One technical effect of utilizing the disclosed subject matter is addressing performance penalty problem by dynamically applying defense mitigations only at local scope of space and time based on breaches being detected during application execution. The anti-ROP defenses may be activated only at the place-and-time of an actual attack, hence eliminating performance and reliability implications. By dynamically activating the randomization only when necessary, unneglectable performance penalty may be introduced.

Another technical effect of utilizing the disclosed subject matter is limiting the code randomization performed in the anti-ROP defenses. As the code randomization may is be performed only on suspected to-be-exposed vulnerability, the code may be randomized only in a limited number of locations within the code. The limited-randomization ease testing of the system under exploit conditions, unlike other randomization techniques that may create a large number of application copies, that their testing may not always be feasible.

It is noted that the disclosed subject matter may be utilized to defend against multi-stage attacks that employ JIT-ROP. In some exemplary embodiments, an attack may comprise several stages, including attacks at different nodes or targeting different assets. As an example, one potential 5-stage attack may include a first stage in which memory exposure is performed. In the second stage, buffer overflow and ROP may be employed using the user privileges of the attacked process. In the third stage, the attacker may scan the breached system to identify all users therein. In the fourth stage, the memory exposure attack may be applied on a process of an administrator user to map its code, and prepare a JIT-ROP attack thereon. In the fifth stage, another control flow hijack vulnerability of the exposed code may be employed to perform malicious activities using administrator privileges. It is noted that the disclosed subject matter may be employed to prevent different phases of such multi-stage attack, such as the first and second stages, the fourth and fifth stages, or the likes. In some cases, additional defensive mechanism may be employed together with the disclosed subject matter to prevent additional phase or sets of phases.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

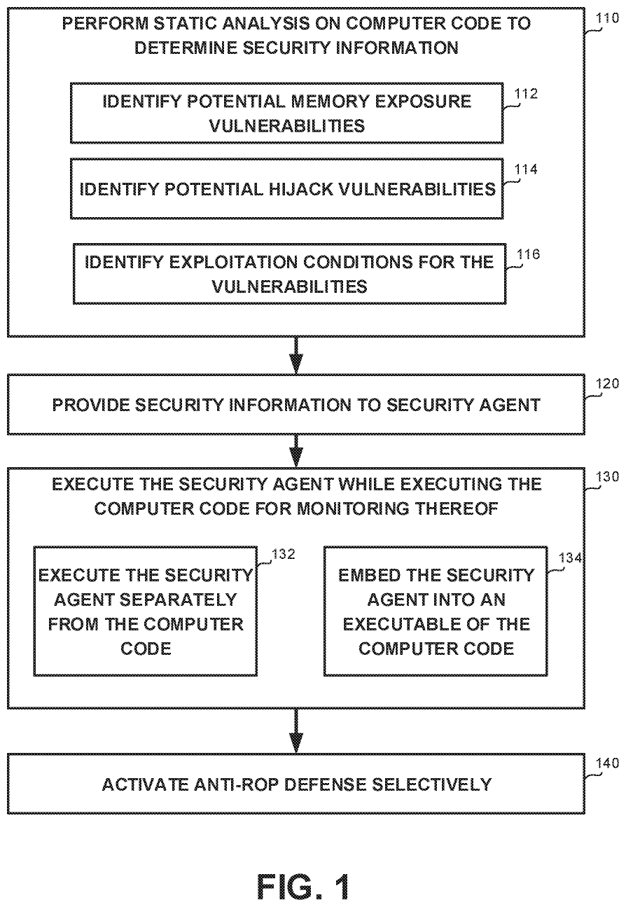

Referring now to FIG. 1 showing a flowchart diagram of a method, in accordance with some exemplary embodiments of the disclosed subject matter.

On Step 110, static code analysis may be performed on a computer code to determine security information. In some exemplary embodiments, the static code analysis may be performed offline on the computer code to determine security information regarding the computer code. The static code analysis may be configured to detect errors is within the computer code such as by source-code analysis. The static code analysis may be performed using lint-like tools, formal verifiers, or the like. As an example, Bugs Errors And Mistakes BEAM analysis tool of IBM™ may be utilized. In some exemplary embodiments, the static analysis may be performed without requiring any information above what is needed for compilation, such as by utilizing lint-like tools. Additionally or alternatively, the static analysis may perform theorem proving in order to determine whether a potential error is feasible, such as by utilizing formal verifiers. A vulnerability may be reported only if there is an input that can exploit it.

On Step 112, potential memory exposure vulnerabilities may be identified in the computer code. In some exemplary embodiments, the security information determined by the static analysis may comprise identified potential memory exposure vulnerabilities within the computer code. Memory exposure vulnerabilities may be weaknesses in the computer code which can be exploited by an attacker, to perform unauthorized memory exposure. The attacker may map the exposed memory to discover API functions, gadgets, or the like, that can be utilized by the attacker to generate malicious computer code to be compiled into the attacked computer code during runtime thereof. The static analysis may be applied to determine such memory exposure vulnerabilities, such as by to analyzing the computer code against a set (or multiple sets) of coding rules to address weaknesses in the code that may lead to memory exposures.

On Step 114, potential control-flow hijack vulnerabilities may be identified in the computer code. In some exemplary embodiments, the static analysis may be applied to determine vulnerabilities within the computer code that may enable the attacker to divert execution to the malicious computer code composed based on exploiting the memory exposure vulnerabilities.

It may be noted that the potential vulnerabilities determined on Step 112 or Step 114, may comprise both true-positive and false-positive vulnerabilities. Not every vulnerability may be exploited during execution of the computer code.

On Step 116, conditions for exploitation of the vulnerabilities may be identified in the computer code. In some exemplary embodiments, the security information may comprise conditions for vulnerability exploitation, such as expected exposure ranges of the memory exposure vulnerabilities, expected control-flow points to be exploited by the write vulnerabilities, or the like.

On Step 120, the security information may be provided to security agent. In some exemplary embodiments, the security information, comprising the memory exposure vulnerabilities and the control flow hijack vulnerabilities within the computer code may be utilized by the security agent to determine when to trigger an anti-ROP defense.

On Step 130, the security agent may be executed while executing the computer code, in order to monitor the execution of the computer code, in accordance with security information. In some exemplary embodiments, the security agent may be configured to monitor real-time exploitation of vulnerabilities identified on Step 110. Additionally or alternatively, the security agent may be configured to monitor exploitation conditions of the vulnerabilities.

Additionally or alternatively, the security agent may be configured to monitor the memory utilized by the computer code during execution thereof, in order to determine exposure thereof, real-time exploitations by malicious parties, which portions of the memory are exposed at each stage of the execution, or the like.

In some exemplary embodiments, the security agent may embed its instructions within the computer code (Step 134). Runtime defense instructions (such as self-randomization instructions, code modification instructions, or the like) may be added to the computer code, in accordance with the security information (such as per each potential control flow hijack vulnerability). Additionally or alternatively, monitoring instructions may be embedded in the code. Such monitoring instructions may enable the security agent to determine vulnerability exposure and apply the relevant runtime defense instruction, accordingly. As an example, the monitoring instructions may comprise exploitation conditions, may monitor flags associated with alerted potential vulnerabilities, or the like. In response to detecting possible exposure exploitation, the security agent may be configured to compute the suspected exposure range of the memory as a result of the exposure exploitation. The security agent may trigger runtime defense instructions within the relevant exposure range (Step 140). As a result, the defense may be activated only at the place and time of an actual attack, hence eliminating performance and reliability implications.

Additionally or alternatively, the security agent may be executed separately from the computer code (Step 132). As an example, the security agent may be a separated application that externally monitor execution of the computer code, and apply relevant defenses on the code during runtime thereof (Step 140).

On Step 140, an anti-ROP defense may be activated selectively during the run-time of the computer code, based on the monitoring performed by the security agent. In some exemplary embodiments, the anti-ROP defense may be performed directly by the security agent on the relevant code portions of the computer code. Additionally or alternatively, the anti-ROP defense may be performed by another party, another security agent, or the like.

In some exemplary embodiments, the appropriate anti-ROP defense to be activated, may be selected based on the type of the vulnerability being exploited. As an example, for stack buffer over flow, randomization may be added to variables placed on the stack by functions in exposed portion of the computer code. As another example, for heap buffer overflow, randomization of No Operation instruction (NOPs) may be performed at the beginning of every buffer allocated on the heap. As yet another example, for Over-read or Format string vulnerabilities, an exploit-condition that triggers re-modification of all suspected buffer-overflow may be added.

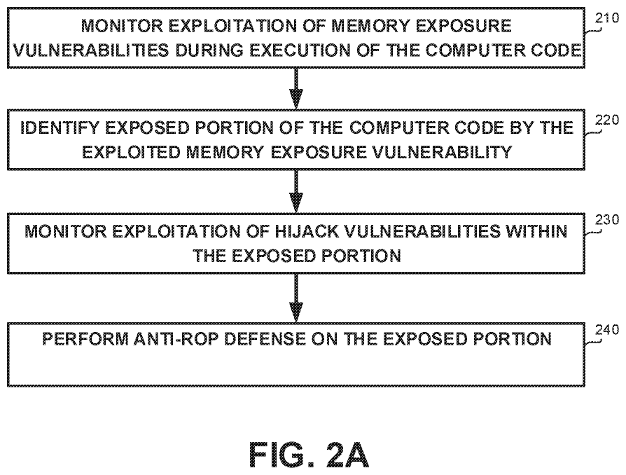

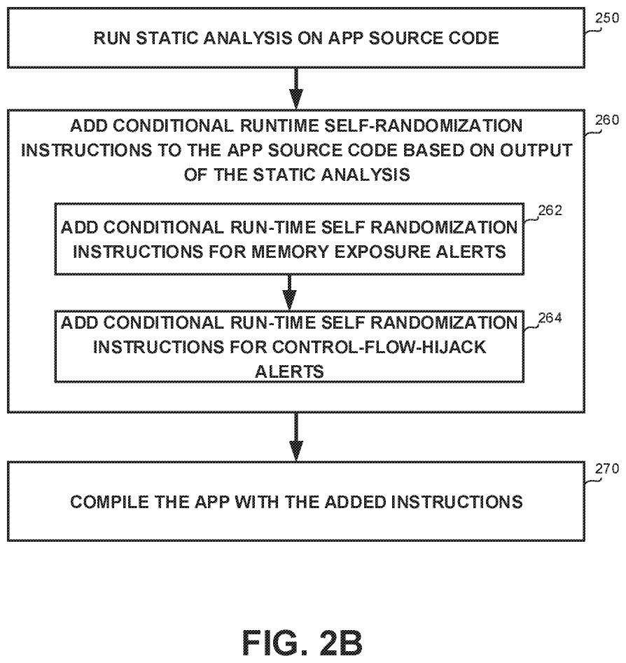

Referring now to FIG. 2A showing a flowchart diagram of a method, in accordance with some exemplary embodiments of the disclosed subject matter.

On Step 210, exploitation of memory exposure vulnerabilities during execution of a computer code, may be monitored. In some exemplary embodiments, the computer code may be monitored and for security check by a dynamic agent during runtime thereof. The monitoring may be performed by an external dynamic agent being executed separately from the computer code (such as on Step 132 of FIG. 1). Additionally or o alternatively, the monitoring may be performed by a security agent being embedded into an executable of the computer code (such as on Step 134 of FIG. 1).

In some exemplary embodiments, the monitoring may be performed in accordance with given security information about potential memory exposure vulnerabilities and exploitation conditions thereof. The given security information may is be obtained based on static analysis on the computer code, being performed before execution of the computer code (such as on Step 110 of FIG. 1, or specifically Step 112 and Step 116).

On Step 220, an exposed portion of the computer code that was exposed by the exploitation of the one or more memory exposure vulnerabilities, may be identified.

On Step 230, exploitation of control flow hijack vulnerabilities within the exposed portion of the computer code, may be monitored. In some exemplary embodiments, an actual exploitation of the control flow hijack vulnerabilities may be monitored. Additionally or alternatively, expected exploitation of the control flow hijack vulnerabilities may be determined, based on security information related to the exploitation of the control flow hijack vulnerabilities. As an example, a likelihood of being exploited may be determined for each control flow hijack vulnerability within the exposed portion. Additionally or alternatively, an expected exploitation of a control flow hijack vulnerability may be determined based on exploitation conditions for exploiting the memory exposure vulnerabilities or the control flow hijack vulnerability, or the like.

On Step 240, an anti-ROP defense may be applied. In some exemplary embodiments, the inti-ROP defense may be performed on the exposed portion, to provide a location-specific defense. Additionally or alternatively, the inti-ROP defense may be performed on the exposed portion, in response to exploitation of a control flow hijack vulnerability therein, thus providing a location-specific and time-specific defense.

Additionally or alternatively, the anti-ROP defense may be performed in response to one or more exploitation conditions of a memory exposure vulnerability or a control flow hijack vulnerability being met. The computer code may be compiled with the changes performed thereon by the anti-ROP defense.

In some exemplary embodiments, the anti-ROP defense may comprise performing an on-the-fly randomization of at least a portion of the computer code, such as the whole exposed portion, portions of the exposed portion, entries of the exposed portion, locations of instructions within the exposed portion, or the like. Additionally or alternatively, the anti-ROP defense may comprise a specific randomization, such as randomizing locations of certain instructions within the exposed portion of the computer code, randomizing order code blocks within the exposed portion, randomizing values within the exposed portion, randomizing popular or know code gadgets within the exposed portion, or the like. Additionally or alternatively, the anti-ROP defense may comprise performing code modifications related to the control flow hijack vulnerabilities identified within the exposed portion. The code modifications may be performed on every potential control flow hijack vulnerability that was identified in the exposed portion, such as obtained from the static analysis, the security information, or the like. As an example, entry points of all control flow hijack vulnerabilities located within the exposed portion of the computer code may be modified. As another example, addresses that point to instructions and may potentially be injected to be utilized during exploitation of a control flow hijack vulnerability may be identified. The code modification may be performed on locations of the instructions pointed to by the addresses. As yet another example, potential control flow values utilized by the potential control-flow hijack vulnerabilities within the exposed portion may be recorded. The anti-ROP defense may comprise overwriting a control flow value that is utilized by at least one control-flow hijack vulnerability, modifying control flow values utilized by the potential control-flow hijack vulnerabilities within the exposed portion, or the like.

Additionally or alternatively, the code modification may be conditioned of exploiting the control flow hijack vulnerability. As an example, the code modification or randomization may be performed only if a likelihood of exploiting the control flow hijack vulnerability identified within the exposed portion is above a predetermined certainty threshold, such as above 50%, above 80%, above 90%, or the like. As an example, entry points of all control flow hijack vulnerabilities located within the exposed portion of the computer code may be modified. As another example, only instructions pointed by addresses that point to instructions and being utilized by an exploited control flow hijack vulnerability may be modified. As yet another example, the anti-ROP defense may be performed only with respect to control flow values utilized by control-flow hijack vulnerabilities within the exposed portion that are expected to be exploited.

Referring now to FIG. 2A showing a flowchart diagram of a method, in accordance with some exemplary embodiments of the disclosed subject matter.

On Step 250, static analysis may be performed on a source code of an application is or a program, or the like. Step 310 may be similar to Step 110 of FIG. 1. The static analysis may be configured to create a security alert at each location in the source code that is suspected of leading to a vulnerability. As an example, the security alerts may be created in case of a memory exposure, a control flow hijack, or the like.

On Step 260, conditional runtime self-randomization code may be added at locations in the source code, that were alerted by the static analysis.

In some exemplary embodiments, conditional runtime self-randomization code may be added for memory exposure alerts (Step 262). The conditional runtime self-randomization code may be designed to determine if the alerted vulnerability is possible being exploited. The conditional runtime self-randomization code may be further designed to determine which of the alerted control flow hijack vulnerabilities may be exploited as a result of a possible exploitation of a memory exposure vulnerability, and trigger self-randomization thereof.

In some exemplary embodiments, conditional runtime self-randomization code may be added for control flow hijack alerts (Step 264). The conditional runtime self-randomization code may be designed to randomize a location of the attack entry (in order to perform stack randomization). The conditional runtime self-randomization code of the control flow hijack alerts may be triggered based on exploiting the relevant memory exposure vulnerability.

On Step 270, the application or the program may be compiled with the added instructions.

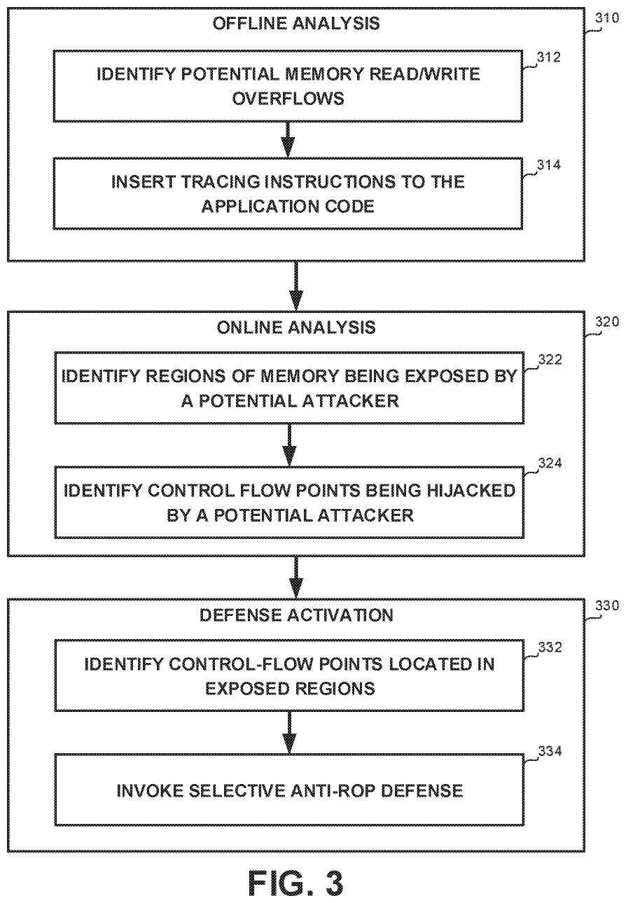

Referring now to FIG. 3 showing a flowchart diagram of a method, in accordance with some exemplary embodiments of the disclosed subject matter.

The method showed in FIG. 3, is in accordance of an embodiment of the disclosed subject matter.

On Step 310, an offline analysis may be performed on an application source code, prior to executing the application. In some exemplary embodiments, the offline analysis may comprise static code analysis, a manual analysis, a combination thereof, or the like.

On Step 312, potential memory read/write-overflow vulnerabilities in the application source code may be identified. In some exemplary embodiments, a potential memory read/write-overflow may be true-positive vulnerability, e.g., may be exploited during execution of the application. Additionally or alternatively, the potential memory read/write-overflows false-positive vulnerability, e.g., may not be exploited during execution of the application.

On Step 314, tracing instructions may be inserted into the application code. In some exemplary embodiments, the identified vulnerabilities from Step 312, may be utilized as an input for the compiler to insert tracing instructions into the application code. A relevant tracing instruction may be added into the application code for each identified vulnerability to determine whether the vulnerability is exploited during the execution.

On Step 320, an online analysis may be performed on the application's code. In some exemplary embodiments, the compiler may append to the application's code, a monitoring agent (e.g., a dynamic agent) that monitors the application execution, and records by the tracing instruction. The monitoring agent may be configured to identify potential JIT-ROP attacks on the application's code.

On Step 322, regions of the memory that are being exposed by a potential attacker may be identified. In some exemplary embodiments, memory regions may be exposed by exploiting read-overflow vulnerabilities in the application by an attacker. The attacker may exploit the read-overflow vulnerability to disclose the memory layout and discover gadgets that can be utilized to JIT-compile a malicious program composed of a sequence of such gadgets. Such exploitation may be determined by the monitoring agent based on the tracing instructions added on Step 314.

On Step 324, control-flow points that are being hijacked by a potential attacker may be identified. In some exemplary embodiments, an attacker may exploit write-overflow in the application to hijack the application's control-flow. This allows the attacker to divert execution to the malicious program composed by gadgets discovered while exploiting a read-overflow vulnerability. As an example, values written by the attacker on function pointers in the heap, or on the return-address in the stack, may be determined. A trace update indicating a control-flow point being hijacked by an attacker, may be issued in response to such identification. A respective hijacked control-flow value may be recorded each trace update.

On Step 330, an anti-ROP defense may be activated to prevent the JIT-ROP attack.

On Step 332, control-flow points located in exposed regions may be identified. In some exemplary embodiments, each hijacked control-flow value recorded on Step 324, may be checked to determine whether it contains an address that fall within the regions recorded on Step 322.

On Step 334, in response to an address pointed by a hijacked control-flow value being located in an exposed memory region, a selective anti-ROP defense may be invoked.

In some exemplary embodiments, a runtime fine-grained ASLR re-randomization of code-blocks may be performed on code-blocks pointed by hijacked control-flow value. The code-block randomization may invalidate the entry points to the malicious program.

Additionally or alternatively, the hijacked control-flow values may be overwritten with an address of an assert routine which will printout appropriate message to the user and terminate the application.

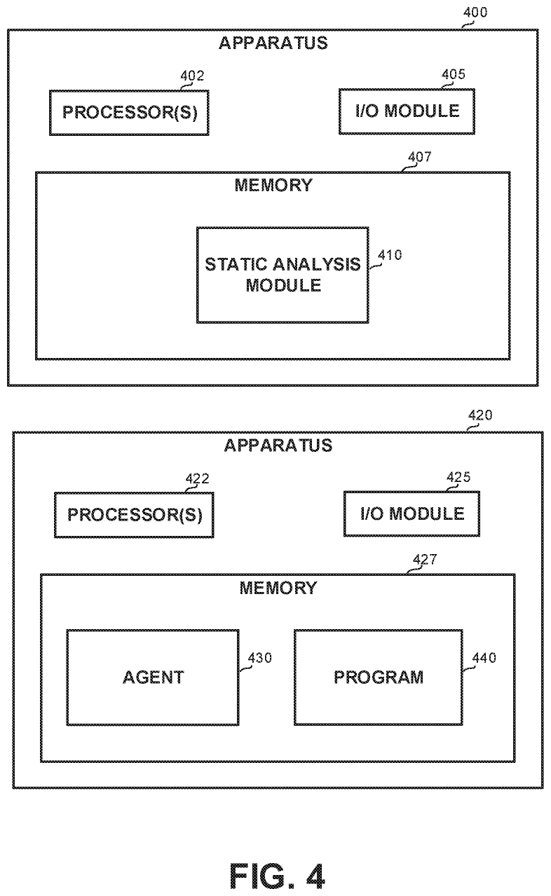

Referring now to FIG. 4 showing a block diagram of an apparatus, in accordance with some exemplary embodiments of the disclosed subject matter. An Apparatus 400 and an Apparatus 450 may be configured to support parallel user interaction with a real world physical system and a digital representation thereof, in accordance with the disclosed subject matter.

In some exemplary embodiments, Apparatus 400 may comprise one or more Processor(s) 402. Processor 402 may be a Central Processing Unit (CPU), a microprocessor, an electronic circuit, an Integrated Circuit (IC) or the like. Processor 402 may be utilized to perform computations required by Apparatus 400 or any of it subcomponents.

In some exemplary embodiments, Apparatus 400 may comprise Memory 407. Memory 407 may be a hard disk drive, a Flash disk, a Random Access Memory (RAM), a memory chip, or the like. In some exemplary embodiments, Memory 407 may retain program code operative to cause Processor 402 to perform acts associated with any of the subcomponents of Apparatus 400.

In some exemplary embodiments of the disclosed subject matter, Apparatus 400 may comprise an Input/Output (I/O) module 405. I/O Module 405 may be utilized to provide an output to and receive input from a user, from Apparatus 420, or the like. As an example, Apparatus 400 may utilize I/O Module 405 to obtain a source code of a computer program, such as Program 440 executed by Apparatus 420, to be analyzed before being executed.

In some exemplary embodiments, Apparatus 400 may comprise a Static Analysis Module 410. Static Analysis Module 410 may be configured to perform static analysis of an obtained source code to determine security information regarding thereof. Static Analysis Module 410 may be configured to perform offline static analysis prior to executing the program.

In some exemplary embodiments, Static Analysis Module 410 may be configured to determine one or more memory exposure vulnerabilities within the source code, such as unauthorized read instructions, reading from to a memory location that is outside of the intended boundary of the buffer, out-of-bounds reads, or the like. Additionally or alternatively, Static Analysis Module 410 may be configured to determine one or more control flow hijack vulnerabilities within the computer code, such as buffer overflow vulnerabilities, integer overflow vulnerabilities, format string vulnerabilities, heap overflow hijacks, structured exception handler attack, or the like.

In some exemplary embodiments, Apparatus 400 may be configured to provide the security information regarding the obtained source code determined by Static Analysis Module 410, to a dynamic agent, such as Agent 430 of Apparatus 420.

In some exemplary embodiments, Apparatus 420 may comprise one or more Processor(s) 422. Processor 422 may be a CPU, a microprocessor, an electronic circuit, an IC or the like. Processor 422 may be utilized to perform computations required by Apparatus 420 or any of it subcomponents.

In some exemplary embodiments of the disclosed subject matter, Apparatus 420 may comprise an I/O module 425. I/O Module 425 may be utilized to provide an output to and receive input from a user, from Apparatus 400, or the like. In some exemplary embodiments, Apparatus 420 may comprise Memory 427. is Memory 427 may be a hard disk drive, a Flash disk, a RAM, a memory chip, or the like.

In some exemplary embodiments, Memory 427 may retain program code operative to cause Processor 422 to perform acts associated with any of the subcomponents of Apparatus 420.

In some exemplary embodiments, Apparatus 420 may be configured to execute an Agent 430 while executing a Program 400, in order to monitor for vulnerabilities exploitation therein. In some exemplary embodiments, Agent 430 may be executed separately from Program 440. Additionally or alternatively, Agent 430 may be embedded into an executable of Program 440, whereby execution of Program 440 also executes Agent 430. In some exemplary embodiments, Apparatus 420 may be configured to obtain security information related to the computer code from Apparatus 400, based on a static analysis of the source code of Program 400. The security information may comprise one or more memory exposure vulnerabilities and one or more control flow hijack vulnerabilities within the computer code.

In some exemplary embodiments, Agent 430 may be configured to monitor exploitation of memory exposure vulnerability while executing Program 440. In response to an exploitation of a memory exposure vulnerability, Agent 430 may be configured to identify, during execution of Program 440, an exposed portion of the computer code of Program 440 that was exposed by the exploitation of the memory exposure vulnerability.

In some exemplary embodiments, in response to the identification of the exposed portion of the computer code of Program 440, Agent 430 may be configured to perform an anti-ROP defense on the exposed portion of Program 440. The anti-ROP defense may comprise performing an on-the-fly randomization of at least a portion of the computer code of Program 440, randomizing locations of instructions within the exposed portion of the computer code of Program 440, or the like.

Additionally or alternatively, Agent 430 may be configured to monitor exploitation of control flow hijack vulnerabilities of the one or more control flow hijack vulnerabilities within the exposed portion of the computer code of Program 440. Agent 430 may be configured to modify entry points of all control flow hijack vulnerabilities located within the exposed portion of the computer code of Program 440.

Additionally or alternatively, Agent 430 may be configured to identify addresses potentially injected to be utilized during exploitation of a control flow hijack vulnerability. Each address may point to an instruction or a gadget that may be utilized by potential attackers to generate malicious code. Agent 430 may be configured to modify locations of the instructions pointed to by such addresses.

Additionally or alternatively, Agent 430 may be configured to record potential control flow values utilized by the one or more control-flow hijack vulnerabilities. Agent 430 may be configured to overwrite a control flow value that is utilized by at least one control-flow hijack vulnerability. It may be appreciated that in some cases, Agent 430 may perform anti-ROP defense only with respect to control flow values of the exposed portion of the computer code.

Additionally or alternatively, Agent 430 may be configured to determine, based on the security information of Program 440, one or more exploitation conditions for exploiting the one or more memory exposure vulnerabilities or the one or more control flow hijack vulnerabilities. Agent 430 may be configured to monitor one or more exploitation conditions and apply anti-ROP defense in response to the one or more exploitation conditions being met.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly o on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
providing security information regarding a computer code to a dynamic agent, wherein the security information comprises: one or more memory exposure vulnerabilities within the computer code and one or more control flow hijack vulnerabilities within the computer code; and
executing the dynamic agent while the computer code is being executed;
wherein the dynamic agent is configured to monitor for exploitation of the one or more memory exposure vulnerabilities,
wherein the dynamic agent is configured to identify, during execution of the computer code, an exposed portion of the computer code that was exposed by the exploitation of the one or more memory exposure vulnerabilities,
wherein in response to the identification of the exposed portion of the is computer code, the dynamic agent is configured to perform an anti-Return-Oriented Programming (ROP) defense.

2. The method of claim 1, wherein the anti-ROP defense comprises performing an on-the-fly randomization of at least a portion of the computer code.

3. The method of claim 1, wherein the anti-ROP defense comprises randomizing locations of instructions within the exposed portion of the computer code.

4. The method of claim 1, wherein the anti-ROP defense comprises modifying entry points of all control flow hijack vulnerabilities located within the exposed portion of the computer code.

5. The method of claim 1, wherein the anti-ROP defense comprises:
identifying an address potentially injected to be utilized during exploitation of a control flow hijack vulnerability, wherein the address points to an instruction; and
modifying a location of the instruction pointed to by the address.

6. The method of claim 1,
wherein the dynamic agent is configured to record potential control flow values utilized by the one or more control-flow hijack vulnerabilities; and
wherein the anti-ROP defense comprises overwriting a control flow value that is utilized by at least one control-flow hijack vulnerability.

7. The method of claim 6, wherein the anti-ROP defense is performed only with respect to control flow values of the exposed portion of the computer code.

8. The method of claim 1 further comprising:
performing static analysis of the computer code to determine the one or more memory exposure vulnerabilities and the one or more control flow hijack vulnerabilities within the computer code.

9. The method of claim 1,
wherein the static analysis is performed offline prior to executing the computer code.

10. The method of claim 1,
wherein said executing the dynamic agent is performed during execution of the computer code, wherein the dynamic agent is executed separately from the is computer code.

11. The method of claim 1,
wherein the dynamic agent is embedded into an executable of the computer code, whereby execution of the computer code also executes the dynamic agent.

12. The method of claim 1 further comprising:
determining one or more exploitation conditions for exploiting the one or more memory exposure vulnerabilities or the one or more control flow hijack vulnerabilities;
wherein the anti-ROP defense is performed in response to the one or more exploitation conditions being met.

13. A computerized apparatus having a processor, the processor being adapted to perform the steps of:
providing security information regarding a computer code to a dynamic agent, wherein the security information comprises: one or more memory exposure vulnerabilities within the computer code and one or more control flow hijack vulnerabilities within the computer code; and
executing the dynamic agent while the computer code is being executed;
wherein the dynamic agent is configured to monitor for exploitation of the one or more memory exposure vulnerabilities,
wherein the dynamic agent is configured to identify, during execution of the computer code, an exposed portion of the computer code that was exposed by the exploitation of the one or more memory exposure vulnerabilities,
wherein in response to the identification of the exposed portion of the computer code, the dynamic agent is configured to perform an anti-Return-Oriented Programming (ROP) defense.

14. The computerized apparatus of claim 13, wherein the anti-ROP defense comprises at least one of:
performing an on-the-fly randomization of at least a portion of the computer code;
randomizing locations of instructions within the exposed portion of the is computer code;
modifying entry points of all control flow hijack vulnerabilities located within the exposed portion of the computer code;
modifying a location of an instruction pointed to by an address potentially injected to be utilized during exploitation of a control flow hijack vulnerability; and
overwriting a control flow value that is utilized by at least one control-flow hijack vulnerability.

15. The computerized apparatus of claim 13, wherein the anti-ROP defense is performed only with respect to control flow values of the exposed portion of the computer code.

16. The computerized apparatus of claim 13, wherein the processor is further adapted to perform the steps of:
performing static analysis of the computer code to determine the one or more memory exposure vulnerabilities and the one or more control flow hijack vulnerabilities within the computer code, wherein the static analysis is performed offline prior to executing the computer code.

17. The computerized apparatus of claim 13,
wherein said executing the dynamic agent is performed during execution of the computer code, wherein the dynamic agent is executed separately from the computer code.

18. The computerized apparatus of claim 13,
wherein the dynamic agent is embedded into an executable of the computer code, whereby execution of the computer code also executes the dynamic agent.

19. The computerized apparatus of claim 13, wherein the processor is further adapted to perform the steps of:
determining one or more exploitation conditions for exploiting the one or more memory exposure vulnerabilities or the one or more control flow hijack vulnerabilities;
wherein the anti-ROP defense is performed in response to the one or more exploitation conditions being met.

20. A computer program product comprising a non-transitory computer readable storage medium retaining program instructions, which program instructions when read by a processor, cause the processor to perform a method comprising:
providing security information regarding a computer code to a dynamic agent, wherein the security information comprises: one or more memory exposure vulnerabilities within the computer code and one or more control flow hijack vulnerabilities within the computer code; and
executing the dynamic agent while the computer code is being executed;
wherein the dynamic agent is configured to monitor for exploitation of the one or more memory exposure vulnerabilities,
wherein the dynamic agent is configured to identify, during execution of the computer code, an exposed portion of the computer code that was exposed by the exploitation of the one or more memory exposure vulnerabilities,
wherein in response to the identification of the exposed portion of the computer code, the dynamic agent is configured to perform an anti-Return-Oriented Programming (ROP) defense.
